(19) United States
(12) Patent Application Publication
(10) Pub. No.: US 2007/0288530 A1
(43) Pub. Date: Dec. 13, 2007

(54) Method and a system for backing up data and for facilitating streaming of records in replica-based databases

(75) Inventors: Yaniv Romem, Jerusalem (IL); Eran Leiserowitz, Kiryat-Ono (IL); Avi Vigder, Petach-Tikva (IL); Gilad Zlotkin, Mevasseret Zion (IL)

Correspondence Address: Martin D. Moynihan;PRTSI, Inc., P.O. Box 16446, Arlington, VA, 22215, US

(73) Assignees: Xeround Systems Ltd., Yahud (IL); Xeround Systems Inc., Menlo Park, CA (US)

(21) Appl. No.: 11/808,211

(22) Filed: Jun. 7, 2007

Related U.S. Application Data
(60) Provisional application No. 60/811,783, filed on Jun. 8, 2006.

(51) Int. Cl. G06F 17/30

(52) U.S. Cl. 707/202

(57) ABSTRACT

A system for backing up a set of records. The system comprises a database in which to store the set of records and a data management module configured for backing up the set of records in a plurality of record groups in a first continuous data batch using a single data stream in the database and simultaneously logging a plurality of transactions related to one or more of the set of records in the first continuous data batch. Each record group has one or more records of said set of records. The system is designed for recovering said set of records from the first continuous data batch.

### RELATED APPLICATIONS

The present application claims priority from U.S. Provisional Patent Application No. 60/811,783, filed on Jun. 8, 2006, the contents of which are herein incorporated by reference.

### FIELD AND BACKGROUND OF THE INVENTION

The present invention relates to data storage and, more particularly, but not exclusively to improvements and mechanisms for allowing efficient data storing in replica databases and retrieving data therefrom.

In highly-available distributed data management systems, every critical data element is replicated in order to ensure recovery of database records. Such a replication is performed in order to ensure the availability of data in the case of failure of one of the computing units or memory elements. It is usually required for a large system to have a carrier grade availability that generally denotes that the network is available almost all of the time (99.999%) for all available services. In order to ensure such a grade, it is typically required to store three copies of each data record in three different hosting units, such as an autonomous database server or a virtual partition of a common database server. It is assumed that each one of the hosting units has 99.9% availability for all available services.

A general approach for implementing a real-time highly-available distributed data management system that uses three or more backup copies is disclosed in pending International Patent Application Pub. No. WO/2006/090367, filed Nov., 7, 2005, which is hereby incorporated by reference in its entirety and discloses a system having database units arranged in virtual partitions, each independently accessible, a plurality of data processing units, and a switching network for switching the data processing units between the virtual partitions, thereby to assign data processing capacity dynamically to respective virtual partitions. In such an embodiment, a majority-voting process is used in order to ensure the accuracy of the backup copies from the virtual partitions. The backup copies are sufficient for assuring safe completion of any read or write operation.

In order to implement such a mechanism for backing up a set of records, a memory space which is equivalent to the memory space of the set of records has to be allocated. As several backups are usually stored in order to ensure a safe recovery of the system, a relatively large amount of memory is needed.

Usually, during the backing up operation, a checkpoint is generated for each set of records from time to time. The checkpoint may be understood as an identified snapshot of the set of records or a point at which the transactions updating the database have been frozen. In addition, any transaction made by the system is stored in order to back up any changes made between the generations of the checkpoints.

The process of keeping records of transactions is called transaction logging or simply logging. The records of the transactions, which may be referred to as log records or logged transactions, are stored in a portion of disk space separate from the checkpoints.

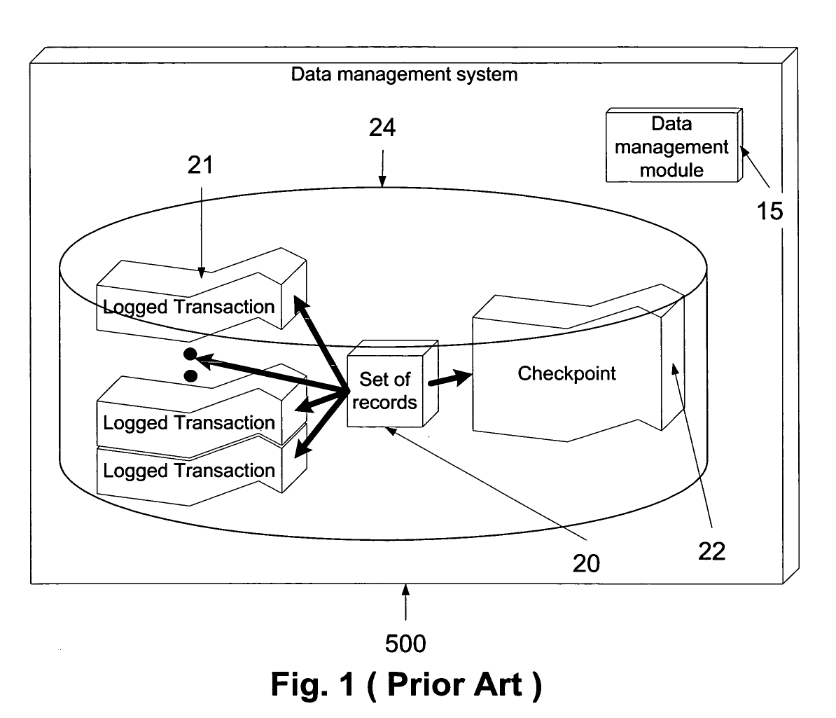

Reference is now made to FIG. 1, which is a schematic illustration of a data management system having a data management module 15 and an exemplary read write memory device 24, such as a disk, which is used as a database and separately stores a checkpoint 22 and a number of logged transactions 21, according to instructions from the data management module 15. As the checkpoint 22 and the logged transactions 21 are separate from one another, they may be stored on different platters of the disk 24.

The checkpoint 22 is a reference version of a set of records 20 that is stored on the disk 24. The transactions 21 are logged to disk 24 as they are committed to the set of records 20 in the database 24. By using the checkpoint 22, the logged transactions have sufficient information to restore the set of records 20 to a point at which the last transaction has been logged.

In order to ensure recovery of the set of records at any given moment, a second checkpoint is generated before the first checkpoint is deleted. Therefore, a space for storing two checkpoints is needed. In addition, the number of logged transactions grows between the generations of every two checkpoints. Such a growth requires a substantial amount of memory if the time quantum between the generations of every two checkpoints is too large. Only when the second checkpoint has been written, the old logged transactions may be deleted, together with the first checkpoint.

Therefore, in order to improve the robustness of the system, the balance between the amount of memory that is used for storing the logged transactions and the frequency of the checkpoint generation has to be tuned.

It should be noted that when such a solution is integrated into the read/write memory 24 it may cause high data-cache latency. As the same read/write memory is used for storing the checkpoints 22, logs of transactions 21, and the data that is currently in use, simultaneous instructions for updating both the checkpoint 22 and the transaction logs 21 may thrash the system that uses the read/write memory 24. For example, recurrent tasks for logging transactions in one section in one platter of the direct read/write memory which are assigned during the generation of a checkpoint in another section in another platter of the direct read/write may cause repetitive movement of the head of the direct read/write and inhibit the completion of the checkpoint generation. The redundant movements increase the time and energy requirements of performing each one of the tasks separately. The increase occurs, inter alia, because the disk read/write heads have to maneuver across the multiple platters of the disk in order process data in two or more different areas of the disk. Therefore, a solution that allows backing up of the data, which is devoid of the above limitations, is needed.

### SUMMARY OF THE INVENTION

According to one aspect of the present invention there is provided a system for backing up a set of records. The system comprises a database in which to store the set of records and a data management module configured for backing up the set of records in a plurality of record groups in a first continuous data batch using a single data stream in the database and simultaneously logging a plurality of transactions related to at least one of the set of records in the first continuous data batch, each the record group comprises at least one record of the set of records. The system is configured for recovering the set of records from the continuous data batch.

According to another aspect of the present invention there is provided a method for backing up a set of records. The method comprises a) backing up a plurality of groups, each the group containing at least one record of a set of records in a first continuous data batch using a single data stream, b) during the backing up, logging a plurality of transactions in the first continuous data batch, each the transaction updating at least one of the set of records, and c) maintaining a predefined ratio between a storage space needed for the logged transactions and a storage space needed for backing up groups.

According to another aspect of the present invention there is provided a method for backing up records for a set of records. The method comprises a) receiving a call to log at least one transaction and a request to backup a replica of the set of records, b) generating a combined data batch containing the replica and the at least one transaction, and c) recovering the set of records according to the combined data batch.

According to another aspect of the present invention there is provided a method for backing up an array of records. The method comprises a) bisecting the array of records to a first and a second sub-array respectively, each sub array is of substantially equal size, b) using an exclusive disjunction connective for generating an exclusive disjunction vector according to the first and second sub-arrays, and c) outputting the exclusive disjunction vector and the first and second sub-arrays as a backup to the array of records.

According to one aspect of the present invention there is provided a method for retrieving at least one record from a plurality of replica databases having a plurality of records in a common partial order. The method comprises a) forwarding a request from a requestor for a subgroup of the plurality of records to each one of the replica databases, b) receiving a plurality of responses to the request from the replica databases, each the response comprises records of the subgroup ordered according to their relative position in the common order, c) choosing among respective records of the responses using a majority-voting algorithm, and d) forwarding the chosen respective records to the requestor before all the records of the subgroup have been received.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### In the Drawings:

FIG. 1 is a schematic illustration of a known data management system having an exemplary database that employs a known backup mechanism;

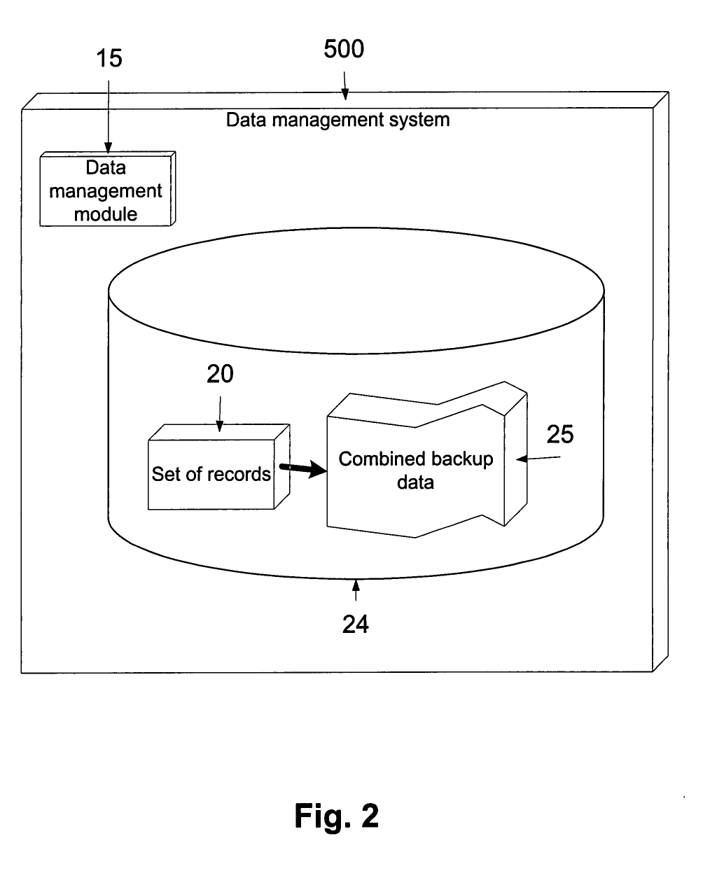

FIG. 2, is a schematic illustration of a data management system, such as a distributed data management system, having an exemplary database and employing a backup mechanism, according to one embodiment of the present invention;

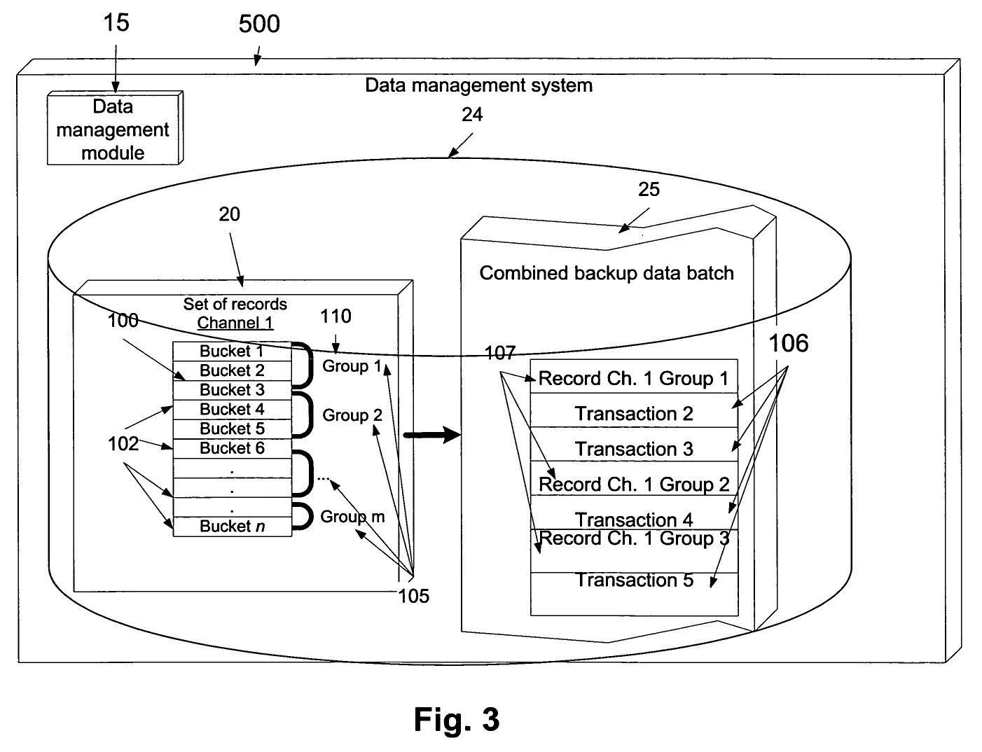

FIG. 3 is a schematic illustration of a data management system having an exemplary database, such as a distributed data management system, that stores a channel, according to one embodiment of the present invention;

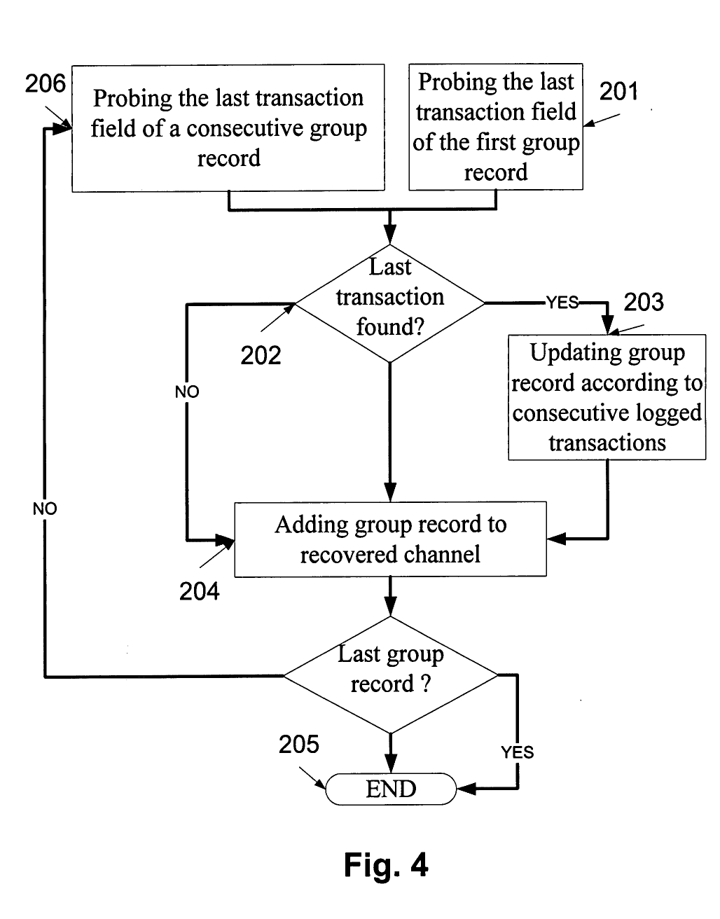

FIG. 4 is a flowchart of a process for recovering a channel, according to one embodiment of the present invention;

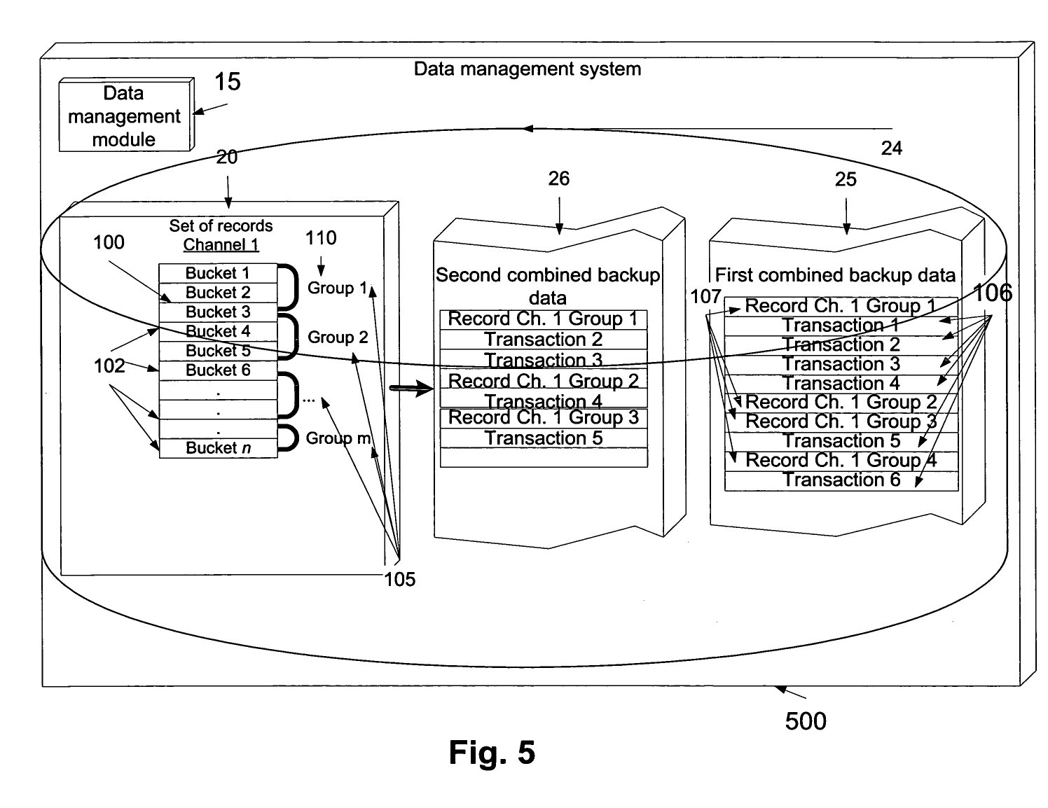

FIG. 5 is a schematic illustration of the data management system, as described in FIG. 3, wherein the database stores an additional backup batch, according to one embodiment of the present invention;

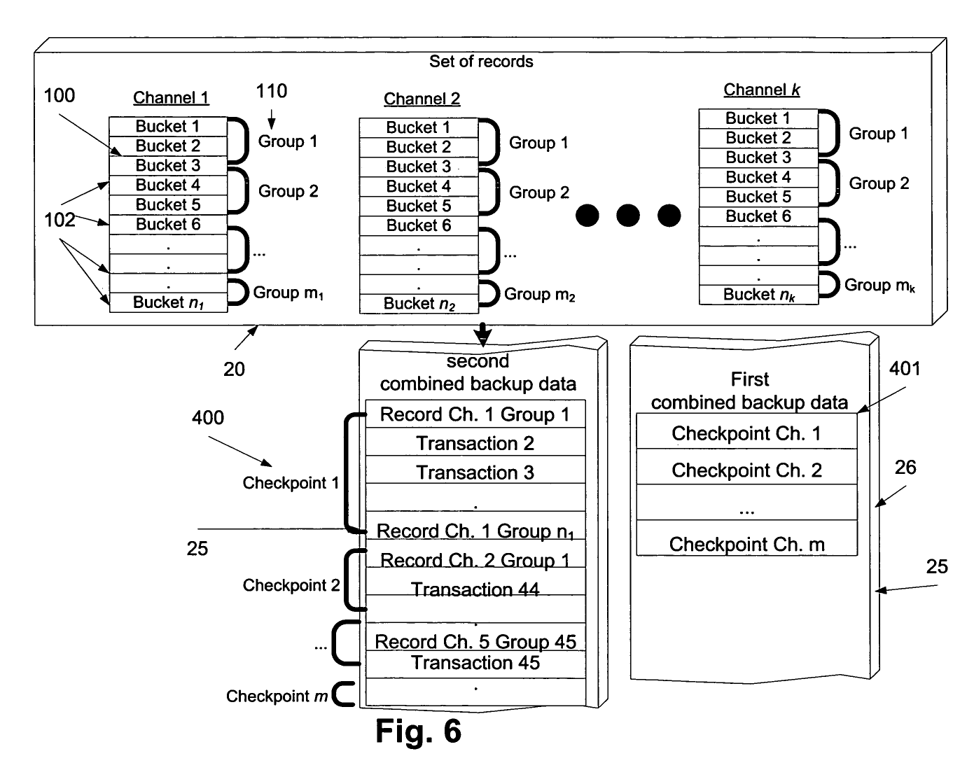

FIG. 6 is a schematic illustration of the set of records, as described in FIG. 3, according to one embodiment of the present invention;

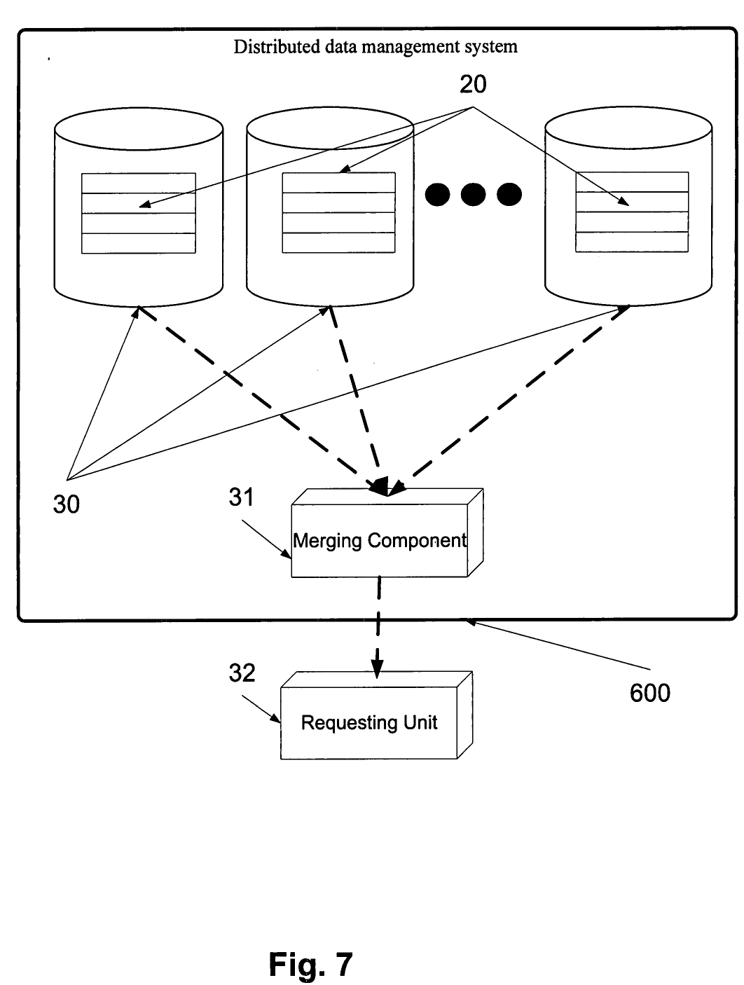

FIG. 7 is a schematic illustration of the data management system, according to one embodiment of the present invention. In the depicted embodiment, the data management system is distributed and comprises a set of databases and a merging component;

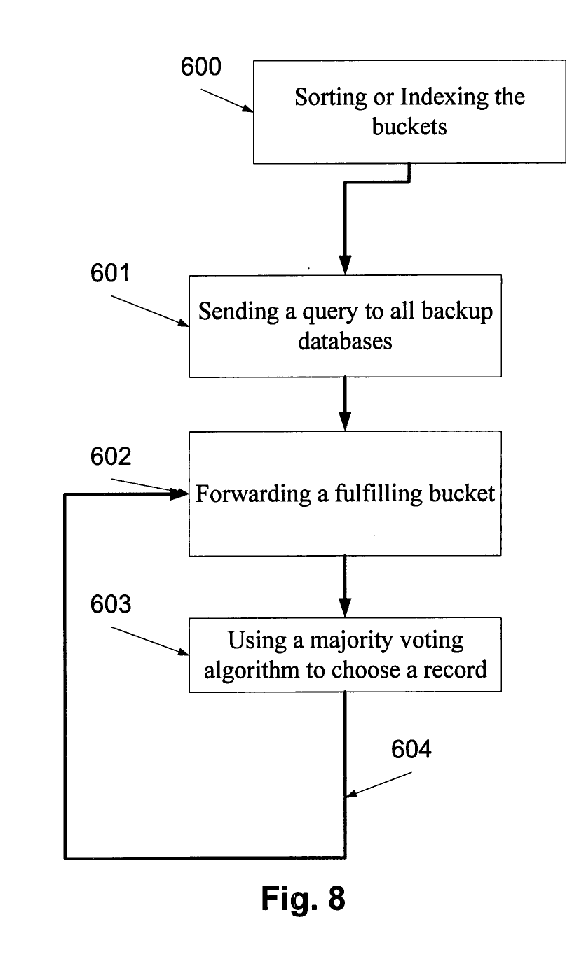

FIG. 8 is a flowchart of an exemplary method for searching and retrieving information from databases, according to a preferred embodiment of the present invention;

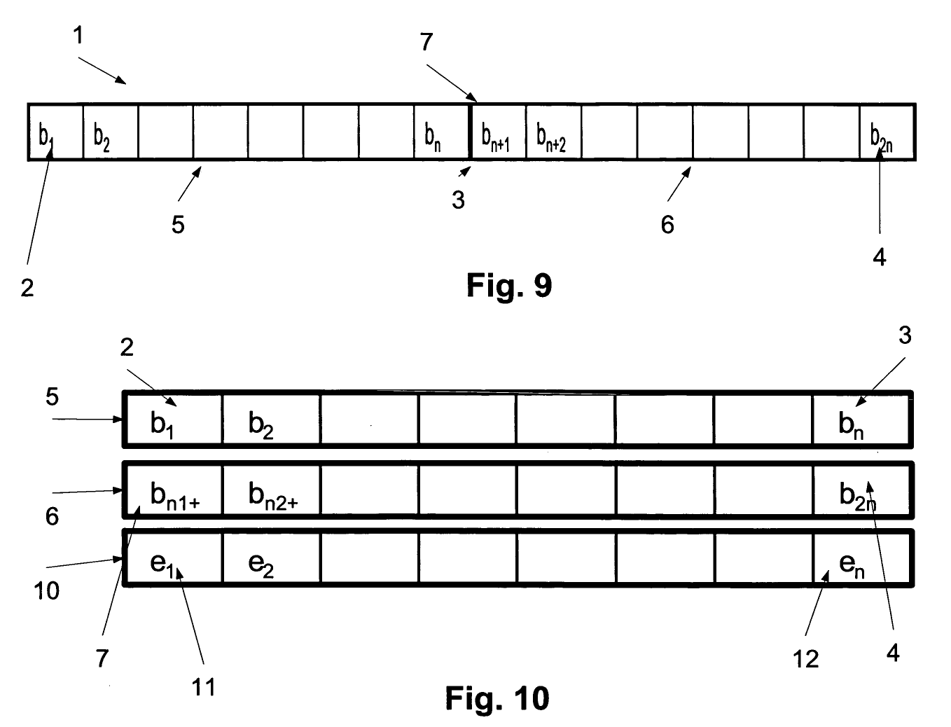

FIG. 9 is a graphical representation of an array of data units, according to a preferred embodiment of the present invention; and

FIG. 10 is another graphical representation of the array of data units of FIG. 9 and of an exclusive disjunction vector, according to one preferred embodiment of the present invention.

### DESCRIPTION OF THE PREFERRED EMBODIMENTS

The present embodiments comprise systems and methods for backing up data and for facilitating streaming of records in replica-based databases. According to one aspect of the present invention, there is provided a system for backing up checkpoint information and logging transactions of a set of records in a common data batch. The system comprises a database that hosts the set of records and the common data batch, which is continuous, and a data management module that manages the backing up process. The management module backs up a number of groups in the continuous data batch, where each one of the groups contains one or more of the records of the set of records. At the same time, the management module logs transactions that update one or more of the records of the set of records in the continuous data batch. The transactions are logged in the common continuous data batch. The data management module is designed for recovering the set of records from the first continuous data batch.

The principles and operation of a system and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

A bucket may be understood as a data unit, a bit, a sequence of adjacent bits, such as a byte, an array of bits, a massage, or a file.

A channel may be understood as an array of buckets, an array of data massage, or a file.

A logged transaction may be understood as a record or a log record that documents one or more changes made to one or more records stored in a related database during one or more transactions.

A database may be understood as a data repository such as a server, a hard disk or any other device which is used for storing data and a set of data that is required for a specific purpose or is fundamental to a system, a project, an enterprise, or a business.

Reference is now made to FIG. 2, which is schematic illustration of a data management system 500, such as a distributed data management system, having an exemplary database 24 that hosts a set of data 20 and a continuous backup element 25. The system 500 further comprises a data management module 15 for employing a backup mechanism, according to one embodiment of the present invention. Though only one exemplary database 24 is depicted in FIG. 3 a number of databases may be used in the data management system 500. For example, if the data management system 500 is distributed, a number of databases, each as shown at 24, may be used for storing a number of independent copies of the set of records 20.

The data management module 15 may include a database management system (DBMS) that facilitates the creation and maintenance of the database 24. As depicted in FIG. 2, the backup database 24 comprises a continuous backup element 25, such as a file or a set of concatenated files that is used for storing both checkpoint information and transaction logs. The continuous backup element 25 may be referred to as a combined backup data batch 25 which is generated using a single data stream that is a single sequence of digitally encoded signals. Optionally, the data management module 15 maintains a balance between the space which is allocated for the checkpoint information and the space which is allocated for the logged transactions in the combined backup data batch 25. The balance is optionally determined according to one or more variable parameters, as described below. Such a balance reduces the disk space that is used for storing the logged transactions and checkpoint information.

Optionally, the space that is needed for storing the logged transactions and the space which is needed for storing the checkpoint information are balanced in a manner that an equal amount of memory is kept for each one of them. For example, for every n data units which are allocated for storing the checkpoint, n data units are allocated for the logged transactions. Optionally, the combined backup data batch 25 comprises 2n data units.

Optionally, two combined backup data batches are used for storing the checkpoints and the logged transactions. Each combined backup data batch 25 comprises checkpoint information and all the transactions which occurred during the generation of the checkpoint. Each combined backup data batch 25 represents the status of the system at a certain time interval in which it was created.

It should be noted, that the deletion of a combined backup data batch 25 may be a lengthy activity. In order to reduce the time that elapses during the deletion activity, and in order to reduce the processing time of generating and maintaining the combined backup data batch 25, a number of small backup files may be used for storing the combined backup data batch 25. Each backup file optionally stores a portion of the checkpoint information and the logged transactions. Since the size of the files that are used is smaller, the performance time for storing, maintaining, and deleting, the data is reduced and the latency may respectively decrease.

Optionally, a ratio of 1:1 between the size that is needed for storing the logged transactions and the size that is needed for storing the checkpoint data is kept. Optionally, each checkpoint is divided into a number of backup files. The number of backup files is optionally between 10 and 100 files.

Reference is now made to FIG. 3, which is another schematic illustration of the data management system 500, according to one embodiment of the present invention. The exemplary database 24 is as depicted in FIG. 2, however, the set of records 20 comprises a channel 100 having a set of buckets 102 and the complete combined backup data 25 that may be represented as a continues a sequence of digitally encoded signals during the retrieval thereof includes a number of logged transactions 106 and a number of record group copies 107, which are arrange in a common array, as described below. The buckets may be divided into m groups 105 where each group includes a number of consecutive buckets. The channel comprises n buckets. Optionally the set of buckets 102 is associated as a hashing table or lookup table (LUT).

As described above, though only one exemplary database 24 is depicted in FIG. 3 a number of databases may be used in a distributed data management system. For example, International Patent Application Pub. No. WO/2006/090367, filed Nov. 7, 2005, which is hereby incorporated by reference in its entirety, describes a method and apparatus for distributed data management in a switching network that backups a channel in a number of channel replicas, each stored in a different server or a virtual partition.

Optionally, the buckets 102 in the channel 100 are backed up in m backing-up cycles. In use, for every backing-up cycle, a different group of buckets is backed up in a group record. The group records are stored in the combined backup data batch 25, as shown at 107. Simultaneously, every transaction that is performed on the data that is stored in one of the buckets of the channel 20 is logged in the combined backup data batch 25, as shown at 106. In such a manner, after m backing-up cycles all the n buckets and the transactions that have been performed on each one of the n buckets since the first backing-up cycle are stored in the combined backup data batch 25. The m group records 107 may be used as a checkpoint reference to all the logged transactions 106 and allows a recovery of all the records of the channel 20.

Optionally, each one of the group records 106 comprises a last transaction field that stores a pointer to or an identifier of the last logged transaction that has changed or updated the data in the buckets thereof. For example, if group 1 includes buckets 1, 2, and 3 and the last transaction made on these buckets before the writing of group record 1 into the combined backup data batch 25 has changed a value stored in bucket 1, a pointer to this logged transaction or an identifier thereof is stored in the last transaction field of group record 1. In such an embodiment, buckets of a certain group are recovered by updating their values according to logged transactions that have been logged after the logged transaction that is stored in the last transaction field.

During the recovery process, the group records 106 may be recovered in a consecutive order. After the buckets in the first group record are recovered, the buckets in the second group record are recovered and added thereto and so on and so forth. In such a manner, the buckets are restored to their original location before the recovery.

Reference is now made jointly to FIG. 3 and to FIG. 4, which is a flowchart of a process for recovering a channel, according to one embodiment of the present invention. During the first step, as shown at 201, the last transaction field of the first group record 110 is probed. Then, as shown at 202, if the last transaction field is null, the buckets in the first group record are added to the recovered channel, as shown at 204. If the last transaction field comprises an identifier of or a pointer to a certain logged transaction, the buckets in the group record are updated according to the logged transactions in the combined backup data batch which have been logged subsequently to the logging of the logged transaction in the last transaction field, as shown at 203. Then, as shown at 204, the buckets of the updated group record are added to the recovered channel. If the added group record is the last group record in the channel, for example the m record group in FIG. 3, the process for recovering the channel is ended, as shown at 205. However, if the added group record is not the last group record in the channel, the last transaction field of the consecutive group record in the combined backup data batch 25 is probed, as shown at 206. Then, steps 202-204 are respectively repeated. In the end of the process, the channel, for example channel 1 of FIG. 3, is recovered.

Reference is now made to FIG. 5, which is a schematic illustration of the data management system 500, as described in FIG. 3, wherein the database 24 stores a second combined backup batch 26, according to one embodiment of the present invention. As described above, all the buckets of the channel are backed up in the first combined backup file 25 in m sessions. Optionally, in order to ensure constant availability of the backed up data in the combined backup data batch 25 and keeping a reasonable ratio between the storage space of the group records 107 and the logged transactions 106, a new set of groups records that includes copies of buckets that embed the logged transactions 106 is generated, for example as stored in the second combined backup batch 26. Such an updated set of records incorporates all the transactions which are logged in the combined backup data batch 25 and therefore allows the deletion thereof without reducing the availability of the backed up data. Optionally, the ratio between the transaction data and the checkpoint data is kept 1:1.

In particular, during the first session of m backing up cycles the first combined backup file 25 has been generated. Then, a new session for storing the m group records 105 is initiated, wherein all the group records 105 and the logged transactions are stored in the second combined backup file 26. In such a manner, it is assured that the information that is stored in the backed up buckets of the first combined backup batch 25 are available until the second combined backup data batch 26, which comprises more up-to-date buckets, is ready and allows the deletion of the first combined backup file 25. Optionally, this process is repetitive and when one combined backup data batch is deleted a new one is generated.

In particular, after all the buckets 102 in the set of records 20 have been backed up in the second combined backup data batch 26, the first combined backup data batch 25 is deleted, the second combined backup data batch 26 is tagged as the first combined backup data batch 25, and a new second combined backup data batch 26 is generated. The process is continually repeated in order to maintain the availability of the backed up data.

Optionally, if the set of records 20 has to be recovered during the generation of the second combined backup data batch 26, both the first and the second combined backup data batches 25, 26 are used for recovery. In such an embodiment, group records, which are not backed up in the second combined backup data batch 26, are taken from the first combined backup data batch 25.

Optionally, the first and the second combined backup data batches 25, 26 are stored continually in a common file. Optionally, the first and the second combined backup data batches 25, 26 are stored in separate files.

Reference is now made to FIG. 6, which is a schematic illustration of the set of records 20, as described in FIG. 3, according to one embodiment of the present invention. In FIG. 6, the set of records 20 comprises k channels. Each channel includes nₖ buckets which are respectively divided to mₖ groups.

During the backing up process, buckets from all the k channels are stored in the first combined backup data batch 25. The buckets are stored simultaneously to the logged transactions, preferably in groups, as described above. In such an embodiment, each logged transaction may describe a change to a value in a bucket of a different channel. Similarly to the embodiments described above, after all the buckets 102 in the set of records 20 have been backed up in the second combined backup data batch 25, the second combined backup data batch 25 is tagged as the first combined backup data batch 26, and a new second combined backup data batch 26 is generated.

Optionally, the channels are backed up seriatim. After all the mₖ₋ₓ groups of a certain channel k−x have been backed up in the second combined backup data 26, mₖ₋ₓ₊1 groups of channel k−x+1 are backed up, etc. Every set of groups of a certain channel are stored simultaneously with logged transactions that occur during the backing up thereof. Optionally, the backed up groups of a specific channel and the logged transactions that have occurred during the backing up thereof are used as a checkpoint for the specific channel. In such an embodiment, the first and second combined backup data batches 25, 26 are designed to store m consecutive checkpoints 400, 401.

In order to reduce the memory space that is needed for backing up the channels, a checkpoint that comprises all the mₓ groups of a certain channel x that is stored in the first combined backup data 26 may be deleted after a respective checkpoint is stored in the second combined backup data 26. For example, if the first combined backup data batch 25 stores copies of all the buckets of the set of records 20 and the second combined backup data batches 26 stores an up-to-date checkpoint of channel 1, a checkpoint of channel 1 in the first combined backup data batch 25 may be deleted. Such a memory saving is achievable as the up-to-date checkpoint of channel 1 backs up all the buckets of channel 1. In addition, all the logged transactions at the checkpoint in the first combined backup data batch 25 are already embedded into the buckets which are backed up in the first and second combined backup data batches 25, 26. These logged transactions are embedded as the buckets in the second combined backup data batches 26 have been backed up after the generation of the deleted checkpoint and therefore represent a version that includes the changes documented in the logged transactions.

Reference is now made to FIG. 7, which is a schematic illustration of a distributed data management system 600, according to one embodiment of the present invention. In the depicted embodiment, the distributed data management system 600 comprises a set of databases 30 and a merging component 31. Optionally, each one of the databases in the set 30 is part of a local data management system, as defined in FIG. 3 or in FIG. 5. The system is connected to one or more requesting units 32 and designed to receive data requests therefrom. Although only one requesting unit 32 is depicted, a large number of requesting units may similarly be connected to the system 600.

Optionally, each one of the databases 30 is defined and managed as the database that is shown at 24 of FIG. 3. Optionally, each one of the databases 30 comprises a copy of the set of records 20 that includes one or more channels, for example as depicted in FIG. 6. As described above, the buckets of each channel are ordered in a hash table or accessible using a LUT.

In use, the exemplary distributed data management system 500 receives a request for buckets from the requesting unit 32 and forwards the request to all the databases. Optionally, the request includes one or more bucket identifiers or pointers. As the buckets are associated in a hash table or a LUT, as described above, they may be accessed using the one or more bucket identifiers or hash pointers at a constant-time O(1) lookup on average, regardless of the number of buckets in the set of records. A copy of the requested buckets is streamed from a number of databases 30 to the merging component 31, as further described below. The merging component 31 is used for choosing which buckets to retrieve to the requesting unit 32 from all the received streams. The retrieval is based on an election process, such as a majority-voting process. Optionally, the chosen buckets are those that have the highest representations in the databases 30.

Optionally, the requested one or more buckets are streamed from each one of the databases 30 to the merging component 31 in a predefined consecutive order. For example, buckets with a low identifier number are streamed before buckets with a high identifier number or vice versa. In such an embodiment, the merging component 31 may use a memory space that is substantially smaller than the potential size of the sum of the retrieved records. Such architecture becomes possible, since the buckets are streamed in a sorted order to the merging component. Since the order is uniform, records may be matched and compared without delay at the merging components even before all the records which fulfill the query definitions are streamed from the databases. The merging component may probe respective buckets using the majority-voting mechanism as they are retrieved from the databases 30 and forward the voted bucket, preferably without any delay, to the requesting unit 32. In such an embodiment, as the buckets are forwarded to the requesting unit 32 as they arrive or substantially as they arrive, less memory is needed.

Reference is now made to FIG. 8, which is a flowchart of an exemplary method for searching and retrieving information from databases, according to a preferred embodiment of the present invention.

During the first step, as shown at 600, buckets of each database of a distributed data management system are associated in a common arrangement, such as a predefined order, a hash table or a LUT, in order to ensure the compatibility of the buckets' order. Optionally, the same hashing function is used for generating all the hashing tables at all the databases. The common hashing function facilitates the streaming of requested buckets to a requesting unit in a known order. As described above, all the databases in the distributed data management system are optionally associated with a common arrangement and therefore streamed to the merging component in the same order.

By using such an embodiment, as the buckets are arranged according to a hashing function accessing n buckets in one of the database requires approximately O(1). Such an embodiment may be useful for systems in which the database is constantly being updated.

As shown at 601, during the second step, a request is sent to each one of the databases. Optionally the request is for a set of buckets that fulfill one or more criterions, such as an address, a range of addresses, one or more hash table addresses, etc.

During the following step, as shown at 602, the requested buckets are forwarded or streamed in a uniform order from each one of the databases that store copies of the requested buckets to the merging component. As depicted in step 600, the requested buckets have been accessed using a common hashing function. The predefined order of the hashing function is used to determine the order of the retrieved records in all the databases. As shown at 603, records from one of the databases are compared with respective records from other databases in order to find a majority. As described above, and implemented by the commonly used voting majority algorithm, the record which has the highest representation among all the databases of the set of databases, is retrieved. As shown at 604, after the record has been chosen, the following record is streamed to the merging component in order to be matched in a majority-voting algorithm. As described above, the order or the streamed recorded is determined according to the order which has been determined in step 600. The order, as described above, is determined either by the sort or by the hashing function. This process is repetitive and repeats itself until all the requested records have been transferred to the requesting unit from the set of databases.

A number of methods may be used in order for decreasing the memory space that is needed for storing data, such as the aforementioned set of records and the backups thereof, in a system, such as distributed data management system. The following section describes a method for decreasing the amount of memory that is used in order to ensure carrier grade availability, as further described below.

Reference is now made to FIG. 9, which is a graphical representation of an array of buckets 1, such as a channel. As shown at 4, the array of buckets 1 comprises an even number of buckets 2. In order to ensure the array of buckets 1 may be bisected to equal sub-arrays later on in the process, the array of buckets 1 should comprise an even number of buckets. Preferably, the array of buckets 1 comprises 2n buckets, where n denotes an undefined variable. If the array comprises an uneven number of buckets, an additional bucket is added to the array of buckets 1 in order to promise an even amount of buckets. As shown at 3 and 4, the array of buckets 1 comprises first and second potential sub-arrays 5, 6. The first bucket of the first and the second potential sub-arrays are shown at 2 and 7 respectively. The last bucket of the first and the second potential sub-arrays are shown at 3 and 4 respectively. In order to backup the array of buckets 1, error correcting code (ECC) Techniques are used, as described below.

Reference is now made to FIG. 10, which is an alternate graphical representation of the array of buckets 1 wherein the first and second sub-arrays 5, 6 of the array of buckets 1 as separately drawn.

As described above, in order to ensure carrier grade availability, it is typically required to have three or more copies of the records. Accordingly, at least three different elements with 2n each are needed in order to ensure such a carrier grade. As commonly known, the requirement for at least three different elements that represent the data is needed to ensure that the recorded information may be recovered using at least two backup copies. For example, in a system, that uses a majority-voting mechanism, at least three copies are used to backup the system and at least two of them are used for recovery, as they constitute a majority.

Optionally, ECC technique are used in order to decrease the amount of memory which is needed for backing up the array of buckets 1 while ensuring a carrier grade availability, as described above. In one embodiment, as shown at FIG. 10, the array of buckets 1 is divided to first and second sub arrays 5, 6, each having n buckets. Preferably, a connective in logic known as the “exclusive OR” (XOR) or exclusive disjunction is used to generate an additional array 10 which comprises n buckets. Each bucket of the additional array 10 represents the outcome of the following equation:

AYB=(AI B)Y(!AI B)=C

where A denotes a bucket from the first sub entry, B denotes a respective bucket from the second subentry, C denotes the outcome of the XOR operation which is stored on a respective bucket of the additional array, I denotes AND operation, Y denotes OR operation, and Y denotes XOR operation.

The additional array 10 and sub arrays 5 and 6 allow the recovery of the original data from two different copies of elements that represent the data, as required for ensuring carrier grade availability.

The XOR operation is associative, so [symbol] is the same as [symbol] . Accordingly, each combination of two arrays may be used for reconstructing the array of the buckets 1. By concatenating the first and second array, the array of buckets 1 is reconstructed. Since the XOR operation is associative, the outcome may be used for reconstructing the elements which have been used to generate it. Hence, by using the XOR connective on the first array and the additional array the second array may be reconstructed. By using the XOR connective on the second array and additional array, the first array is reconstructed. The reconstruction become possible since the outcome of the XOR operation is associative, and therefore by using the XOR connective on the additional array which is a XOR operation outcome and one of the arrays, which have been used for generating it, the other of the arrays may be constructed.

It should be noted that the sum of buckets of the first, the second, and the additional arrays is 3n. Optionally, each one of the arrays 5, 6, and 10 is maintained in a different database of a distributed data management system. Clearly, by maintaining 3n buckets instead of 6n, a substantial amount of memory is saved and approximately the same robustness is achieved. Using such an embodiment has further implications on the performance of the system. The elements that represent the information take less physical memory while providing approximately the same degree of data security, and therefore the latency of storing and retrieving the data decreases.

It is expected that during the life of this patent many relevant devices and systems will be developed and the scope of the terms herein, particularly of the terms data, database, communication, bucket, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for backing up a set of records, comprising:
a database in which to store the set of records; and
a data management module configured for backing up said set of records in a plurality of record groups in a first continuous data batch using a single data stream in said database and simultaneously logging a plurality of transactions related to at least one of said set of records in said first continuous data batch, each said record group comprising at least one record of said set of records;
wherein the system is configured for recovering said set of records from said continuous data batch.

2. The system of claim 1, wherein said database is configured for retrieving data with high speed.

3. The system of claim 1, wherein said data management module is configured for maintaining a predefined ratio between a storage space needed for said logged transactions and said plurality of group records in said first continuous data batch.

4. The system of claim 3, wherein said maintaining is performed by deleting a first subgroup of said plurality of group records, each member of said first subgroup backing up a record of said set of records having a backup in another record group of said plurality of group records, said another record group being stored after said members of said first subgroup.

5. The system of claim 4, wherein said maintaining is performed by deleting a second subgroup of said logged transactions, each member of said second subgroup being logged prior to a backup of a certain record of said record groups which is not a member of said first subgroup.

6. The system of claim 1, wherein said data management module is configured for documenting a last logged transaction in each said backed up group, said documented last logged transaction being used for updating records of said backed up group during said recovering.

7. The system of claim 1 being configured for connecting with a plurality of systems, each said system comprising said database and said data management module for backing up a respective copy of the set of records.

8. The system of claim 1, wherein said backing up is performed continuously.

9. The system of claim 3, wherein said set of records comprises a plurality of data arrays, said plurality of record groups being stored sequentially from said number of data arrays, said maintaining being performed by deleting a subgroup of said plurality of record groups, said subgroup comprising members of said plurality of record groups having a more up-to-date version.

10. The system of claim 1, wherein said continuous data batch comprises a set of concatenated files.

11. A method for backing up a set of records, comprising:
a) backing up a plurality of groups, each said group containing at least one record of a set of records in a first continuous data batch using a single data stream;
b) during said backing up, logging a plurality of transactions in said first continuous data batch, each said transaction updating at least one of the set of records; and
c) maintaining a predefined ratio between a storage space needed for said logged transactions and a storage space needed for backing up groups.

12. The method of claim 11, wherein said maintaining comprising deleting a first subgroup of said backed up groups that have been backed up before a second subgroup of said backed up groups, said first and second subgroups backing up common records of said set of records.

13. The method of claim 12, wherein said maintaining comprising deleting a third subgroup of said logged transactions, members of said third subgroup having been logged in said first continuous data batch before any of said second subgroup has been stored.

14. The method of claim 11, further comprising recovering said set of records according to said first continuous data batch.

15. The method of claim 11, wherein said backing up is performed continuously.

16. The method of claim 11, wherein said plurality of groups and said plurality of transactions backs up said set of records, further comprising repeating a) to c), thereby generating a second version of said plurality of groups and transactions.

17. The method of claim 16, further comprising deleting said plurality of groups and transactions and maintaining said second version of said plurality of groups and transactions.

18. A method for backing up records for a set of records, comprising:
a) receiving a call to log at least one transaction and a request to backup a replica of the set of records;
b) generating a combined data batch containing said replica and said at least one transaction; and
c) recovering said set of records according to said combined data batch.

19. A method for backing up an array of records, comprising:
a) bisecting said array of records to a first and a second sub-array respectively, each sub array being of substantially equal size;
b) using an exclusive disjunction connective for generating an exclusive disjunction vector according to said first and second sub-arrays; and
c) outputting said exclusive disjunction vector and said first and second sub-arrays as a backup to said array of records.

20. The method of claim 19, wherein each one of said first and second sub-arrays and said exclusive disjunction vector are stored in different databases respectively.

21. A method for retrieving at least one record from a plurality of replica databases having a plurality of records in a common partial order, comprising:
a) forwarding a request from a requestor for a subgroup of said plurality of records to each one of said replica databases;
b) receiving a plurality of responses to said request from said replica databases, each said response comprising records of said subgroup ordered according to their relative position in said common order;
c) choosing among respective records of said responses using a majority-voting algorithm; and
d) forwarding said chosen respective records to said requester before all the records of said subgroup have been received.

22. The method of claim 21, wherein said forwarding is performed without any delay.
